(19) United States
(12) Patent Application Publication
(10) Pub. No.: US 2016/0018696 A1
(43) Pub. Date: Jan. 21, 2016

(54) LENS ARRAY SUBSTRATE, ELECTRO-OPTIC DEVICE, AND ELECTRONIC APPARATUS

(71) Applicant: Seiko Epson Corporation, Tokyo (JP)

(72) Inventor: Satoshi Ito, Eniwa-shi (JP)

(21) Appl. No.: 14/792,589

(22) Filed: Jul. 6, 2015

(30) Foreign Application Priority Data
Jul. 16, 2014 (JP) 2014-145661

(51) Int. Cl. G02F 1/1335; G02B 1/14; G02F 1/1337; G02B 3/00

(52) U.S. Cl. CPC G02F 1/133526; G02B 3/0006; G02B 1/14; G02F 1/133734

(57) ABSTRACT

A lens array substrate (counter substrate) includes a plurality of concaves (lens surface) made of a concave surface formed on one substrate surface (a surface side facing device substrate) of a light-transmitting substrate. In addition, a light-transmitting lens layer, a light-transmitting layer, a light-transmitting protective layer, a common electrode made of an ITO film, and a second alignment film made of an obliquely deposited film are sequentially laminated on the one substrate surface of the light-transmitting substrate. The light-transmitting layer is made of a silicon oxynitride film (light-transmitting layer containing nitrogen), and the protective layer is made of a light-transmitting material not containing nitrogen such as a silicon oxide film or an aluminum oxide film.

### BACKGROUND

1. Technical Field

The present invention relates to a lens array substrate on which a lens is formed, an electro-optic device including the lens array substrate, and electronic apparatus including the electro-optic device.

2. Related Art

In an electro-optic device (liquid crystal device) used as a light valve and the like of a projector, a plurality of pixels are disposed in a matrix shape in a display region, and the pixels display only light reaching a light-transmitting region (pixel opening region) surrounded by a wiring and the like. Therefore, a configuration of converging light from the light source to a light-transmitting region is proposed by configuring an electro-optic device using a lens array substrate as a counter substrate. At this time, a light-transmitting layer (path layer) made of a silicon oxide film with a proper thickness is provided between a lens array and a liquid crystal driving electrode made of an ITO film and the like, and thereby a configuration in which an optical path length is adjusted is proposed (see JP-A-2012-226069).

When a light-transmitting layer containing nitrogen such as a silicon oxynitride film is used as a light-transmitting layer in configuration of a lens array substrate, there is an advantage such as a thin thickness of the light-transmitting layer due to a high refractive index.

However, the present inventors found out a problem that a surface of an ITO film is rough as shown in FIG. 7C when using a light-transmitting layer containing nitrogen such as a silicon oxynitride film as a light-transmitting layer and the like, and forming a liquid crystal driving electrode made of the ITO film on a surface of the light-transmitting layer containing nitrogen. It is not preferable to have such roughness of a surface because the roughness eventually decreases surface properties of an alignment film when forming the alignment film made of an obliquely deposited film on a surface of the ITO film. In particular, when using a liquid crystal layer with negative dielectric anisotropy, it is not preferable to have the roughness because the roughness causes a tilt angle of liquid crystal molecules to vary in accordance with a decrease in the surface properties of the alignment film.

In addition, the roughness of a surface when forming an ITO film on a surface of the light-transmitting layer containing nitrogen is considered to be made because the light-transmitting layer containing nitrogen deteriorates an alignment property of the ITO film. For example, the alignment property of the ITO film at a plurality of places on a substrate is investigated, and it is confirmed that an intensity ratio on a (400) surface is high in a sample whose surface is rough.

### SUMMARY

An advantage of some aspects of the embodiments is to provide a lens array substrate which can optimize an alignment property of an ITO film even when a light-transmitting layer containing nitrogen such as silicon oxynitride film is used, an electro-optic device including the lens array substrate, and electronic apparatus including the electro-optic device.

According to an aspect of the embodiments, there is provided a lens array substrate, including a light-transmitting substrate that has a lens surface, the lens surface includes a concave surface or a convex surface is formed on one side surface, a lens layer which covers one side surface of the substrate, the lens layer is light-transmitting and has a different refractive index from the substrate, a light-transmitting layer which contains nitrogen and is provided on a side opposite to the substrate with respect to the lens layer, a protective layer which covers a surface of the light-transmitting layer on a side opposite to the substrate, and is made of a light-transmitting material not containing nitrogen, and an indium Tin Oxide (ITO) layer which is formed on a surface of the protective layer on a side opposite to the substrate.

According to the aspect, a light-transmitting layer may be provided on a substrate side with respect to the ITO layer film, but a protective layer made of a light-transmitting material not containing nitrogen may be interposed between the light-transmitting layer and the ITO layer. For this reason, roughness is less likely to occur on a surface of the ITO layer.

In the lens array substrate, the protective layer may be configured to include any of a silicon oxide film and an aluminum oxide film.

In the lens array substrate, the light-transmitting layer may include a silicon oxynitride film.

In this case, it is preferable that the lens layer includes a silicon oxynitride film, and the light-transmitting layer covers the lens layer at a surface on a side opposite to the substrate. In this configuration, since the lens layer and the light-transmitting layer have the same refractive index, it is possible to suppress reflection at an interface between the lens layer and the light-transmitting layer. Therefore, an amount of light contributing to a display is hardly reduced.

According to another aspect of the embodiments, there is provided an electro-optic device which includes the lens array substrate, the electro-optic device including a device substrate which faces one surface side of the substrate with respect to the lens array substrate, and a liquid crystal layer which is disposed between the device substrate and the lens array substrate, in which the device substrate has an electrode driving a liquid crystal and a first alignment film covering the electrode at the lens array substrate side, formed on a surface facing the lens array substrate of the device substrate, and the lens array substrate has a second alignment film formed on a surface of the lens array substrate facing the device substrate so as to cover the ITO layer. In this case, the liquid crystal layer may include liquid crystal molecules with negative dielectric anisotropy, and each of the first alignment film and the second alignment film may be made of an obliquely deposited film, respectively.

The electro-optic device is used as, for example, a light valve of a projection-type display device or a direct view type display device. When using the electro-optic device according to the aspect of the embodiments in the projection-type display device, a light source unit which emits light supplied to the electro-optic device and a projection optical system which projects light modulated by the electro-optic device are provided in the projection-type display device.

### BRIEF DESCRIPTION OF THE DRAWINGS

The invention will be described with reference to the accompanying drawings, wherein like numbers reference like elements.

FIGS. 1A and 1B are explanatory views of an electro-optic device to which the invention is applied.

FIG. 2 is an explanatory view which schematically shows a cross-sectional configuration of the electro-optic device shown in FIG. 1.

FIG. 3 is an explanatory view which shows a planar positional relationship between a lens and a light-shielding layer in the electro-optic device shown in FIG. 1.

FIG. 4 is an explanatory view of a motherboard which is used in a manufacture of a lens array substrate to which the invention is applied.

FIGS. 5A to 5F are process cross-sectional views which show a method of manufacturing the lens array substrate to which the invention is applied.

FIGS. 6A to 6D are process cross-sectional views which show the method of manufacturing the lens array substrate to which the invention is applied.

FIGS. 7A to 7C are explanatory views which show an enlarged common electrode (ITO film) surface when applying the invention.

FIG. 8 is a schematic configuration view of a projection-type display device (electronic apparatus) using the electro-optic device to which the invention is applied.

### DESCRIPTION OF EXEMPLARY EMBODIMENTS

Embodiments of the invention will be described referring to drawings. In a view referred to in a following description, each layer or each member has a different scale so as to be recognizable sizes on a drawing.

### Configuration of an Electro-Optic Device

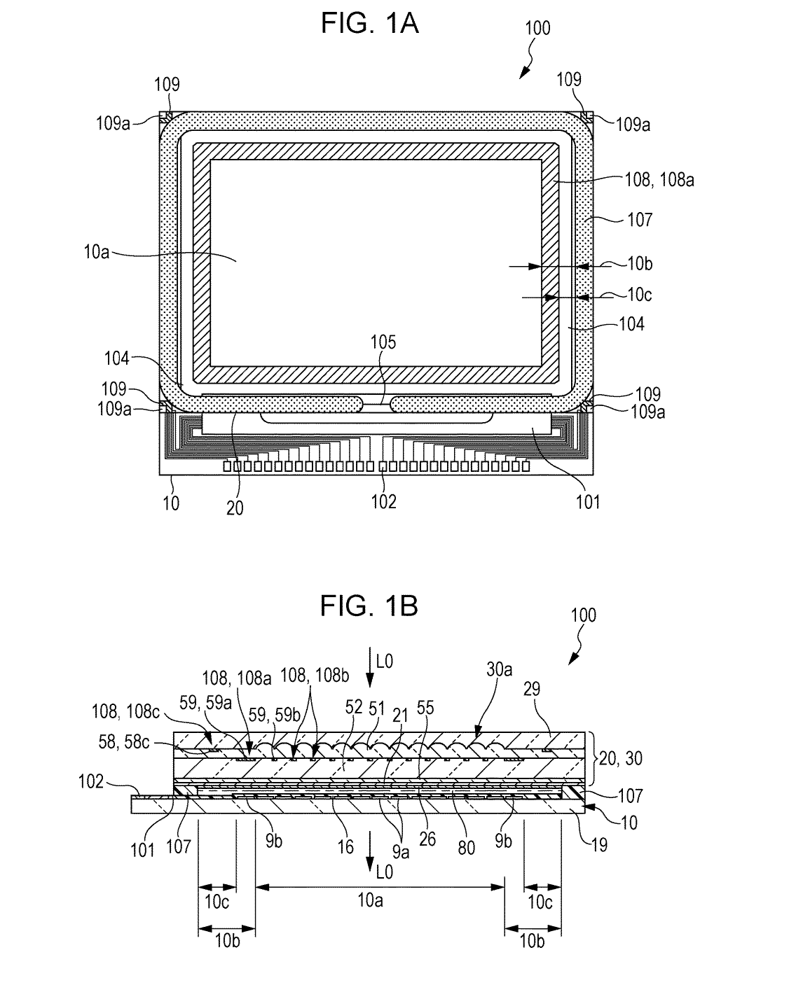

FIGS. 1A and 1B are explanatory views of an electro-optic device 100 to which the invention is applied. FIGS. 1A and 1B are a plan view and a cross-sectional view of the electro-optic device 100 to which the invention is applied from sides of each configuration element and a counter substrate.

As shown in FIGS. 1A and 1B, the electro-optic device 100 includes a light-transmitting device substrate 10 and a light-transmitting counter substrate 20 which are bonded by a sealing material 107 through a predetermined gap, and the device substrate 10 and the counter substrate 20 are opposed to each other. The sealing material 107 is provided in a frame shape along an outer periphery of the counter substrate 20, and a liquid crystal layer 80 is disposed in a region surrounded by the sealing material 107 between the device substrate 10 and the counter substrate 20. Accordingly, the electro-optic device 100 is configured as a liquid crystal device. The sealing material 107 is an adhesive having a photo-curable property, or an adhesive having a photo-curable property and a heat-curable property, and a gap material such as a glass fiber or glass beads for setting a distance between both substrates to be a predetermined value is blended therein. As the sealing material 107, it is possible to use a photo-curable adhesive (ultraviolet photo-curable adhesive/UV curable adhesive) such as an acrylic resin system, an epoxy resin system, an acrylic-modified resin system, an epoxy-modified resin system, and the like.

Both the device substrate 10 and the counter substrate 20 are squares, and the display region 10a is provided substantially at a center of the electro-optic device 100 as a rectangular region. In response to such a shape, the sealing material 107 is also provided in a substantially rectangular shape, and a rectangular frame-shaped peripheral region 10b is provided between an inner peripheral edge of the sealing material 107 and an outer peripheral edge of the display region 10a.

On a surface of the counter substrate 20 side of the device substrate 10, a data line driving circuit 101 and a plurality of terminals 102 are formed along one side of the device substrate 10 on an outer side of the display region 10a, and a scanning line driving circuit 104 is formed along the other side adjacent to the one side. A flexible wiring substrate (not shown) is connected to the terminal 102, and each type of potential and each type of signal are input to the device substrate 10 through the flexible wiring substrate.

In addition, on a surface of the counter substrate 20 side of the device substrate 10, a light-transmitting pixel electrode 9a (liquid crystal driving electrode) made of an indium tin oxide (ITO) film and the like, and a pixel transistor (not shown) electrically connected to the pixel electrode 9a are formed in a matrix form in the display region 10a. A first alignment film 16 is formed on a counter substrate 20 side with respect to the pixel electrode 9a, and the pixel electrode 9a is covered by the first alignment film 16. In addition, a dummy pixel electrode 9b which is formed simultaneously with the pixel electrode 9a is formed in a peripheral region 10b of the device substrate 10.

A light-transmitting common electrode 21 which is made of an ITO film and the like is formed on a surface side facing the device substrate 10 in the counter substrate 20, and a second alignment film 26 is formed on the device substrate 10 side with respect to the common electrode 21. In the embodiment, the common electrode 21 is formed on a substantially entire surface of the counter substrate 20, and the common electrode 21 is covered by the second alignment film 26.

The first alignment film 16 and the second alignment film 26 are inorganic alignment films (vertical alignment film) which are made of obliquely deposited films such as SiOₓ (x<2), SiO₂, TiO₂, MgO, Al₂O₃, In₂O₃, Sb₂O₃, Ta₂O₅, and the like, and liquid crystal molecules having negative dielectric anisotropy used in the liquid crystal layer 80 are aligned in an inclined manner. Therefore, the liquid crystal molecules are at a predetermined angle with respect to the device substrate 10 and the counter substrate 20. In this manner, the electro-optic device 100 is configured as a liquid crystal device in a vertical alignment (VA) mode.

An inter-substrate conduction electrode 109 for taking an electrical conduction between the device substrate 10 and the counter substrate 20 is formed in a region overlapped with a corner portion of the counter substrate 20 at outer side than the sealing material 107 in the device substrate 10. An inter-substrate conducting material 109a including conductive particles is disposed in the inter-substrate conduction electrode 109, and the common electrode 21 of the counter substrate 20 is electrically connected to the device substrate 10 side through the inter-substrate conduction material 109a and the inter-substrate conduction electrode 109. Therefore, the common electrode 21 is applied with a common potential from a side of the device substrate 10.

In the electro-optic device 100 of the embodiment, the pixel electrode 9a and the common electrode 21 are formed by an ITO film (light-transmitting conductive film), and the electro-optic device 100 is configured as a transmission-type liquid crystal device. In the electro-optic device 100, light incident from one substrate side of the device substrate 10 and the counter substrate 20 is modulated while transmitting the other substrate side to be emitted, thereby displaying an image. In the embodiment, as shown by arrow L0, light incident from the counter substrate 20 is modulated on a pixel basis by the liquid crystal layer 80 while transmitting the device substrate 10 to be emitted, thereby displaying an image.

### Configuration of Metal Layer 108

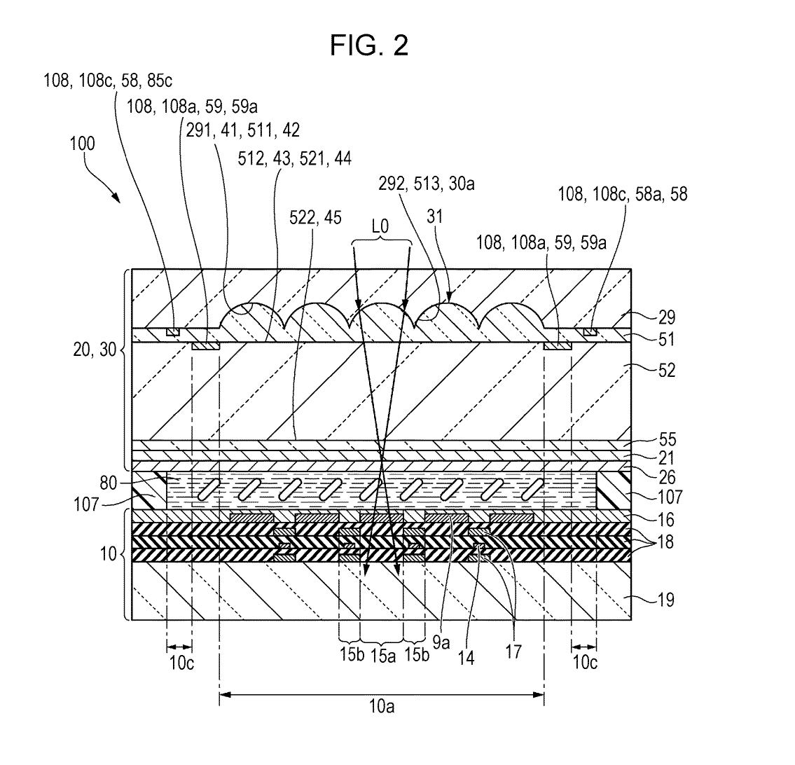

FIG. 2 is an explanatory view which schematically shows a cross-sectional configuration of the electro-optic device 100 shown in FIG. 1. As shown in FIGS. 1 and 2, a light-shielding metal layer 108 made of a metal or a metal compound is formed on a side opposite to the device substrate 10 with respect to the common electrode 21 on the counter substrate 20. The metal layer 108 is formed, for example, as a frame-like parting member 108a extending along an outer periphery of the display region 10a. In addition, the metal layer 108 is formed as a light-shielding layer 108b in a region overlapped with a region in a plan view, which is interposed by adjacent pixel electrodes 9a. Furthermore, the metal layer 108 is formed as an alignment mark 108c in the peripheral region 10b and the like. In the embodiment, among the peripheral regions 10b, the alignment mark 108c is provided in the mark forming region 10c interposed between an outer periphery of the parting member 108a and an inner periphery of the sealing material 107.

### Configuration of Lens Array Substrate 30

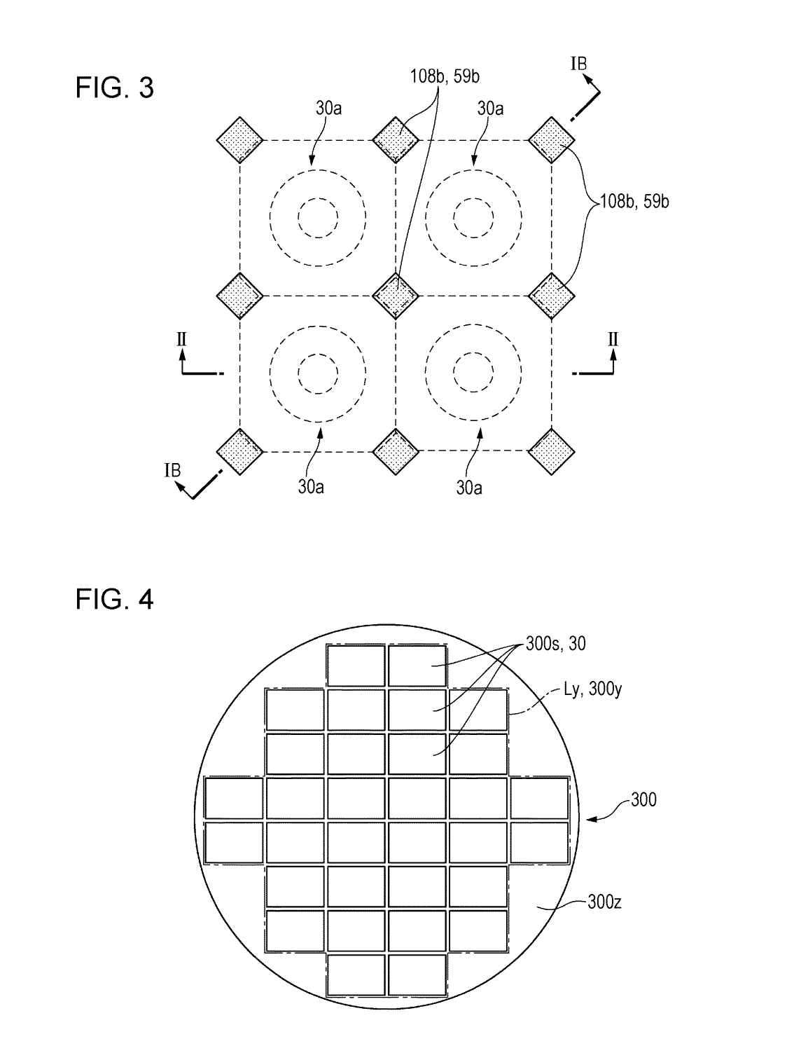

FIG. 3 is an explanatory view which shows a planar positional relationship between a lens 30a and a light-shielding layer 108b in the electro-optic device 100 shown in FIG. 1.

As shown in FIG. 2, the device substrate 10 includes the light-transmitting substrate 19 and a plurality of inter-layer insulation film 18 stacked on a surface of the light-transmitting substrate 19 of the counter substrate 20 side. Moreover, in the device substrate 10, the wiring 17 or the pixel transistor 14 extending along a region overlapped with a space between adjacent pixel electrodes 9a is formed using a space between the light-transmitting substrate 19 and the interlayer insulation film 18 or a space between the interlayer insulation films 18, and the wiring 17 or the pixel transistor 14 does not allow light to be transmitted.

For this reason, among regions overlapped with the pixel electrode 9a in a plan view in the device substrate 10, a region overlapped with a wiring 17 or the pixel transistor 14 in a plan view, or a region overlapped with a region interposed between adjacent pixel electrodes 9a in a plan view becomes a light-shielding region 15b through which light is not transmitted, and a region not overlapped with the wiring 17 or the pixel transistor 14 in a plan view among regions overlapped with the pixel electrode 9a in a plan view becomes an opening region 15a (light-transmitting region) through which light is transmitted. Accordingly, only light transmitting the opening region 15a contributes to an image display, and light towards the light-shielding region 15b does not contribute to the image display.

Therefore, the counter substrate 20 is configured as the lens array substrate 30 on which a plurality of lenses 30a overlapped with the plurality of pixel electrodes 9a one on one in a plan view are formed, and the lens 30a collimates light incident onto the liquid crystal layer 80 in the embodiment.

Therefore, since an optical axis of the light incident onto the liquid crystal layer 80 has a small inclination, it is possible to reduce a phase deviation at the liquid crystal layer 80, and to suppress a lowering of transmittance or contrast. Particularly in the embodiment, since the electro-optic device 100 is configured as a liquid crystal device in a VA mode, the lowering of contrast and the like is likely to occur due to an inclination of the optical axis of the light incident onto the liquid crystal layer 80, but the lowering of contrast is unlikely to occur according to the embodiment.

Here, as shown in FIG. 3, the lenses 30a are arranged so that adjacent lenses 30a are in contact, and the light-shielding layer 108b shown in FIG. 1 is formed in a region overlapped with a region surrounded by four lenses 30a in a plan view. Therefore, the light-shielding layer 108b is shown as a cross-section taken along line IB-IB of FIG. 3 in FIG. 1B. In FIG. 2, the light-shielding layer 108b is not shown as a cross-section taken along line II-II of FIG. 3. The light-shielding layer 108b is overlapped with an end portion of the lens 30a in a plan view in some cases, but the light-shielding layer is formed not to be overlapped with a center of the lens 30a in a plan view.

### Detailed Configuration of Lens Array Substrate 30

In FIG. 2 again, in the embodiment, when configuring the lens array substrate 30 (counter substrate 20), a plurality of concaves 292 (lens surface) made of concave surfaces are formed on a first surface 41 formed from one substrate surface 291 of the light-transmitting substrate 29 (a surface side facing the device substrate 10). In addition, a light-transmitting lens layer 51, a light-transmitting layer 52, and a light-transmitting protective layer 55 to be described below are sequentially stacked on one substrate surface 291 (first surface 41) of the light-transmitting substrate 29, and the common electrode 21 is formed on a side opposite to the light-transmitting substrate 29 with respect to the protective layer 55. The concave 292 is overlapped with the pixel electrode 9a in a plan view.

Among a plurality of light-transmitting films, a first lens layer 51 includes a surface 511 (second surface 42) covering the substrate surface 291 (first surface 41) of the light-transmitting substrate 29, and a planarized surface 512 (third surface 43) positioned on a side opposite to the surface 511 (second surface 42). In addition, the surface 511 (second surface 42) of the first lens layer 51 includes a hemispherical convex portion 513 embedding the concave 292 of the light-transmitting substrate 29.

Here, the light-transmitting substrate 29 and the lens layer 51 are different in refractive index, and the concave 292 and the convex 513 configure the lens 30a. In the embodiment, a refractive index of the lens layer 51 is greater than a refractive index of the light-transmitting substrate 29. For example, while the light-transmitting substrate 29 is made of a quartz substrate (silicon oxide, SiO₂), and the refractive index is 1.48, a lens layer 51 is made of a silicon oxynitride film (SiON), and the refractive index is 1.58 to 1.68. Therefore, the lens 30a has a power for converging light from a light source.

In lens array substrate 30, the light-transmitting layer 52 is formed on a side opposite to the light-transmitting substrate 29 with respect to the lens layer 51. In the embodiment, the light-transmitting layer 52 covers the lens layer 51 at a side opposite to the light-transmitting substrate 29, and includes a surface 521 (fourth surface 44) covering the planarized surface 512 (third surface 43) of the lens layer 51 and a surface 522 (fifth surface 45) positioned at a side opposite to the surface 521 (fourth surface 44). In the embodiment, the light-transmitting layer 52 has the same refractive index as does the lens layer 51. More specifically, the light-transmitting layer 52 is a light-transmitting layer containing nitrogen, which is made of a silicon oxynitride film (SiON) like the lens layer 51. However, the light-transmitting layer 52 has a slightly different nitrogen content from the lens layer 51, and the refractive index is 1.58 to 1.64. The light-transmitting layer 52 is an optical path length adjustment layer to adjust an optical path length from the lens 30a to the liquid crystal layer 80 or the device substrate 10.

### Configuration of Protective Layer 55

In the embodiment, the protective layer 55 is formed so as to cover a surface 522 (a fifth surface 45) of the light-transmitting layer 52 on a side opposite to the light-transmitting substrate 29, and the light-transmitting common electrode 21 (light-transmitting electrode) made of an ITO film is formed on the light-transmitting layer 52 of the protective layer 55 or a surface 522 of an opposite sides to the light-transmitting substrate 29. In addition, the second alignment film 26 is formed on the protective layer 55 or a side opposite to the light-transmitting substrate 29 with respect to the common electrode 21.

In the embodiment, whereas the light-transmitting layer 52 is made of a silicon oxynitride film (light-transmitting film containing nitrogen), the protective layer 55 is made of a light-transmitting material not containing nitrogen. For example, the protective layer 55 is made of a silicon oxide film (SiOₓ) or an aluminum oxide film (Al₂O₃), and does not contain nitrogen. For example, when configuring the protective layer 55 by the silicon oxide film (SiOₓ), tetraethoxysilane (TEOS) (Si(OC₂H₅)₄)) or SiH₄ (monosilane)+O₂ gas is used as raw material gas to perform plasma chemical vapor deposition (CVD).

### Detailed Configuration of the Metal Film 108

In the lens array substrate 30 of the embodiment, the metal layer 108 (parting member 108a, light-shielding layer 108b, alignment mark 108c) described referring to FIG. 1 and the like is configured to include a first metal layer 58 and a second metal layer 59 which are formed on an interlayer and the like of the light-transmitting film as described below.

Specifically, a parting member 59a made of the second metal layer 59 is formed between the planarized surface 512 (third surface 43) of the lens layer 51 and a surface 521 (fourth surface 44) of the light-transmitting layer 52 as a frame-like parting member 108a extending along an outer periphery of the display region 10a in the lens array substrate 30. In addition, the light-shielding layer 59b made of the second metal layer 59 is formed between the planarized surface 512 (third surface 43) of the lens layer 51 and the surface 521 (fourth surface 44) of the light-transmitting layer 52 as the light-shielding layer 108b in the display region 10a. The light-shielding layer 59b is overlapped with an end portion of the lens 30a in a plan view in some cases, but the light-shielding layer is not overlapped with a center of the lens 30a in a plan view. In addition, in a mark forming region 10c, as an alignment mark 108c, an alignment mark 58c made of the first metal layer 58 is formed between a substrate surface 291 (first surface 41) of the light-transmitting substrate 29 and the surface 511 (second surface 42) of the lens layer 51, and the alignment mark 58c is used for positioning in forming the concave 292 on a substrate surface 291 (first surface 41) of the light-transmitting substrate 29.

In the embodiment, the metal layer 108 (the first metal layer 58 and the second metal layer 59) is made of a metal film such as titanium (Ti), aluminum (Al), chromium (Cr), tungsten (W), tantalum (Ta), molybdenum (Mo), palladium (Pd), and a metal compound film such as these nitride films and the like. Moreover, the metal layer 108 may be one of a single-layer film and a double-layer film of the metal film or metal compound film.

### Manufacturing Method of Lens Array Substrate 30

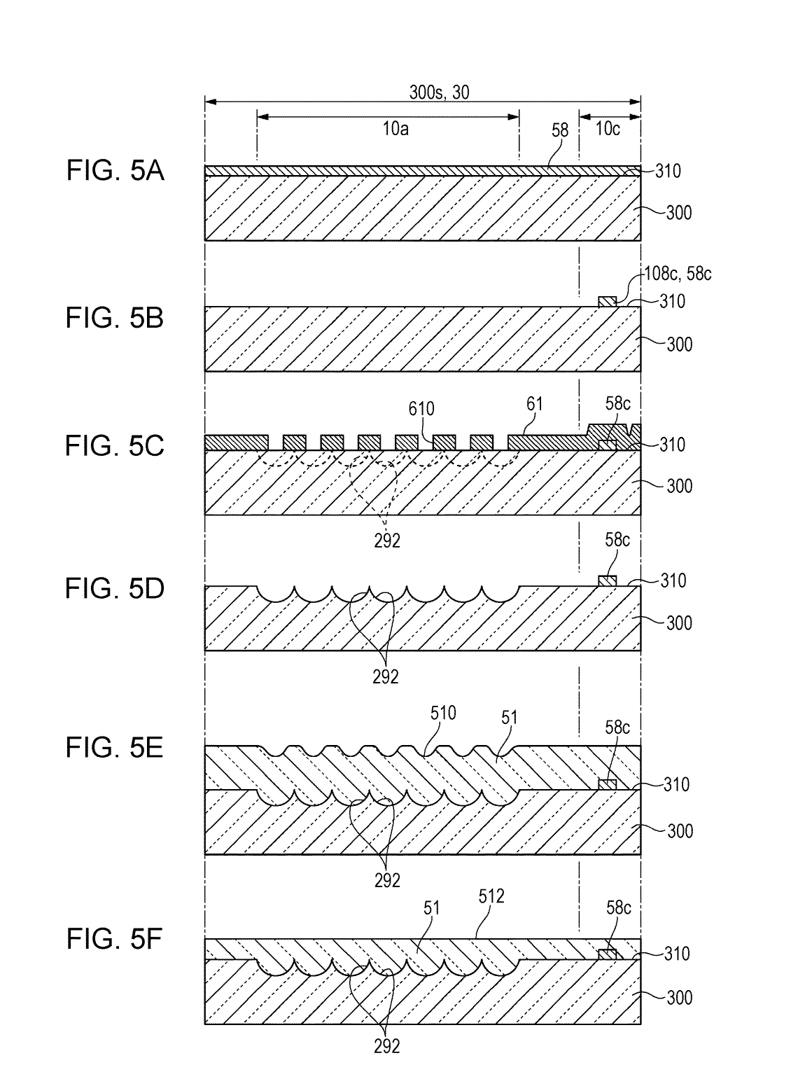

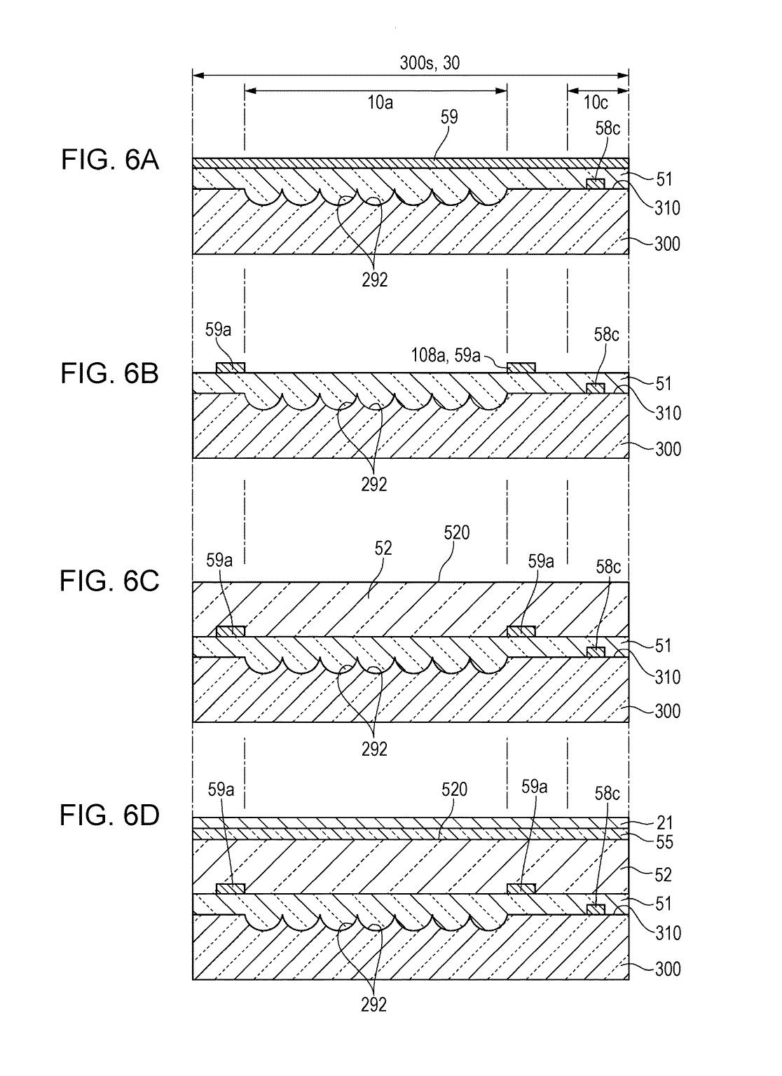

FIG. 4 is an explanatory view of a motherboard 300 which is used in a manufacture of a lens array substrate 30 to which the invention is applied. FIGS. 5 and 6 are process cross-sectional views which show a method of manufacturing the lens array substrate 30 to which the invention is applied. FIGS. 5 and 6, in contrast to FIGS. 1B and 2, express the substrate surface 291 (substrate surface 310 of the motherboard 300) of the light-transmitting substrate 29 used in the lens array substrate 30 upward on drawings.

As shown in FIG. 4, the motherboard 300 made of a quartz substrate larger than the lens array substrate 30 is used in manufacturing the lens array substrate 30 of the embodiment. The motherboard 300 includes a plurality of regions 300s cut as the lens array substrate 30, forms the lens 30a described referring to FIG. 2, the common electrode 21, the second alignment film 26, and the like in the region 300s, and then cuts the motherboard 300 along the region 300s to obtain the lens array substrate 30 in a single-unit size. Accordingly, in the motherboard 300, a region (a region surrounded by a dashed line Ly) in which a plurality of lens array substrates 30 are cut is effective region 300y, and the other region is a removed region 300z which is removed in a cutting process.

In manufacturing the lens array substrate 30 using the motherboard 300, the following processes such as a first metal layer film-forming process, a first metal layer patterning process, a concave formation process, a lens layer film-forming process, a planarization process, a second metal layer film-forming process, a second metal layer patterning process, a light-transmitting layer film-forming process, a planarization process, and a protective layer film-forming process are performed in order.

First, in a first metal layer film-forming process shown in FIG. 5A, the first metal layer 58 made of a metal or a metal compound is formed in the substrate surface 310 of the motherboard 300 by a sputtering method or a deposition method. The first metal layer 58 is made of, for example, a laminated film of titanium nitride and aluminum.

Next, in a first metal layer patterning process shown in FIG. 5B, the first metal layer 58 is etched with an etching mask (not shown) formed on a surface of the first metal layer 58 on a side opposite to the motherboard 300, the first metal layer 58 is removed from an entire display region 10a, and the first metal layer 58 is left as an alignment mark 58c in a mark forming region 10c.

Then, in a concave formation process shown in FIGS. 5C and 5D, a concave 292 (lens surface) is formed in the substrate surface 310 of the motherboard 300. More specifically, as shown in FIG. 5C, after an etching mask 61 having an opening 610 as a region overlapped with an center of the concave 292 is formed in a plan view on the substrate surface 310 of the motherboard 300, isotropic etching is performed using an etching solution containing hydrofluoric acid. As a result, the concave 292 made of a concave surface which sets the opening 610 as a center is formed in the substrate surface 310 of the motherboard 300. Then, as shown in FIG. 5D, an etching mask 61 is removed. In a concave formation process, a light-exposure mask and the like are aligned on a basis of the alignment mask 58c in a photolithography process for forming the etching mask 61.

Then, in a lens layer formation process shown in FIG. 5E, the light-transmitting lens layer 51 having a different refractive index from the motherboard 300 is formed entirely on the substrate surface 310 by a plasma CVD method and the like. At this time, a concave caused by the concave 292 is formed on a surface 510 of the lens layer 51 on a side opposite to the motherboard 300. In a first planarization process shown in FIG. 5F, the surface 510 of the first lens layer 51 is planarized using a chemical mechanical polishing (CMP) process and the like to make the planarized surface 512. In the embodiment, the first lens layer 51 is made of a silicon oxynitride film (SiON). Accordingly, when performing the plasma CVD, as a raw material gas, for example, monosilane (SiH₄) and monoxide nitrogen (N₂O) are used. Ammonia (NH₃) is used as a raw gas in some cases.

Next, in a second metal layer film-forming process shown in FIG. 6A, the second metal layer 59 made of a metal or a metal compound is formed on the planarized surface 512 of the lens layer 51 by a sputtering method, a vapor deposition method, or the like. The second metal layer 59 is made of, for example, a laminated film of titanium nitride and aluminum.

Then, in a second metal layer patterning process shown in FIG. 6B, the second metal layer 59 is etched with an etching mask (not shown) formed on a surface of the second metal layer 59 on a side opposite to the motherboard 300, and the second metal layer 59 is left in the display region 10a as a parting member 59a.

Then, in a light-transmitting layer film-forming process shown in FIG. 6C, the light-transmitting layer 52 is formed on a surface of the lens layer 51 and the second metal layer 59 on a side opposite to the motherboard 300 by a plasma CVD method and the like. A planarization process may be performed using a CNP process and the like on the surface 520 of the light-transmitting layer 52 on a side opposite to the motherboard 300. In the embodiment, the light-transmitting layer 52 is made of a silicon oxynitride film (SiON). Accordingly, when performing the plasma CVD, as a raw material gas, for example, monosilane (SiH₄) and monoxide nitrogen (N₂O) are used.

Then, in a protective layer process shown in FIG. 6D, the protective layer 55 is formed on a surface of the light-transmitting layer 52 on a side opposite to the motherboard 300 by the plasma CVD method.

In the embodiment, the light-transmitting layer 52 is formed by a light-transmitting material not containing nitrogen such as a silicon oxide film (SiOₓ) or an aluminum oxide film (Al₂O₃).

Here, when forming the light-transmitting layer 52 using the silicon oxide film (SiOₓ), as a raw material gas, for example, monosilane (SiH₄) and oxygen (O₂) are used. Moreover, tetraethoxysilane (Si(OC₂H₅)₄) may be used as the raw material gas.

In addition, when forming the light-transmitting layer 52 using the aluminum oxide film (Al203), as a raw material gas, for example, aluminum isopropoxide (Al(iso-OC₃H₇)₃) or the like are used.

Then, in an ITO film forming process, as shown in FIG. 6D, the common electrode 21 made of the ITO film is formed on a surface 552 of the protective layer 55 on a side opposite to the motherboard 300 by a sputtering method or a vapor deposition method.

Then, as shown in FIG. 2, after the second alignment film 26 is formed by an oblique deposition, the motherboard 300 is cut to obtain the lens array substrate 30 (counter substrate 20).

### Main Effect of the Embodiment

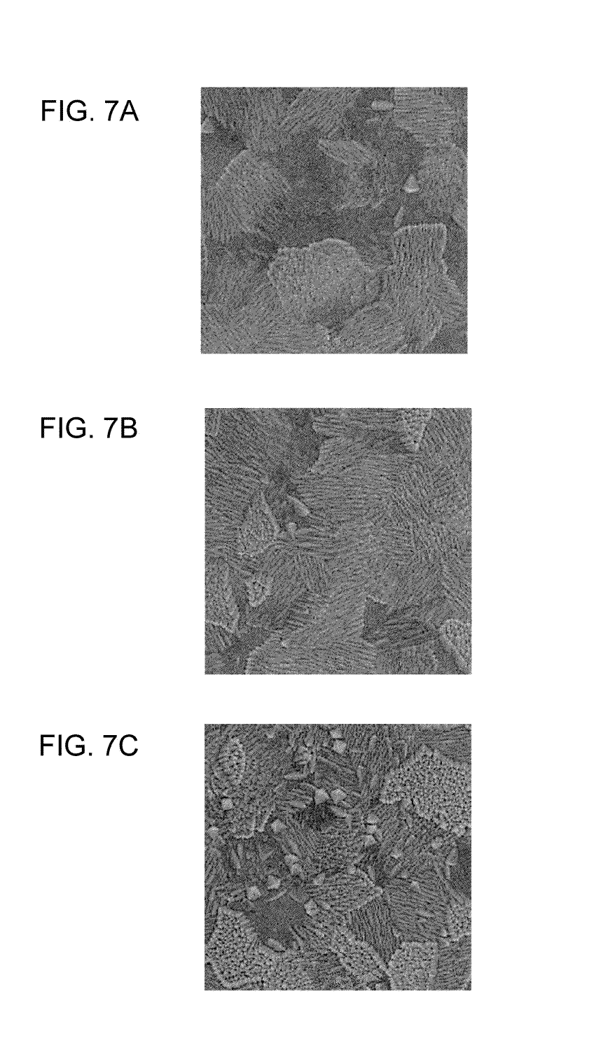

FIGS. 7A to 7C are explanatory views which show an enlarged common electrode 21 (ITO film) surface when the invention is applied, FIGS. 7A, 7B, and 7C are an explanatory view which shows an enlarged ITO film surface when the protective layer 55 made of a silicon oxide film is formed, an explanatory view which shows an enlarged ITO film surface when the protective layer 55 made of an aluminum oxide film is formed, and an explanatory view which shows an enlarged ITO film surface when the protective layer 55 is not formed, respectively.

In the embodiment, as described referring to FIG. 2 and the like, the light-transmitting layer 52 (light-transmitting layer containing nitrogen) is provided at the light-transmitting substrate 29 side with respect to the common electrode 21 (ITO film), but the protective layer 55 made of a light-transmitting material not containing nitrogen is interposed between the light-transmitting layer 52 and the common electrode 21.

Therefore, as shown in FIGS. 7A and 7B, roughness is hardly generated on a surface of the common electrode 21. That is, when directly forming the common electrode 21 on a surface of the light-transmitting layer 52, an intensity ratio on a (400) surface is increased. As a result, roughness is easily generated on a surface of the common electrode 21. In contrast, when the protective layer 55 made of a light-transmitting material not containing nitrogen is interposed between the light-transmitting layer 52 and the common electrode 21, an intensity ratio on the (400) surface is lowered. As a result, roughness is hardly generated on the surface of the common electrode 21. In addition, according to the embodiment, since an intensity ratio on a (222) surface ((111) surface) is increased, roughness is hardly generated on the surface of the common electrode 21. For this reason, since surface properties of the second alignment film 26 become proper, an inclination angle (tilt angle) of liquid crystal molecules used in the liquid crystal layer 80 is stabilized. Therefore, it is possible to display an image of high quality such as excellent contrast in the electro-optic device 100.

In addition, in the embodiment, the light-transmitting layer 52 is made of the same material as the lens layer 51, and has the same refractive index as that of the lens layer 51. Therefore, it is possible to suppress reflection at an interface between the light-transmitting layer 52 and the lens layer 51, such that an amount of light which contributes to a display is hardly reduced. Therefore, it is possible to display a bright image.

Here, when using an aluminum oxide film as the protective layer 55, a refractive index (refractive index=1.67) of the protective layer 55 is in between a refractive index of the light-transmitting layer 52 and a refractive index (refractive index=1.91) of the common electrode 21. Accordingly, compared to when the light-transmitting layer 52 and the common electrode 21 are configured to be directly in contact or when the refractive index of the protective layer 55 is deviated from a range between the refractive index of the light-transmitting layer 52 and the refractive index of the common electrode 21, a refractive index difference at an interface is small. Accordingly, it is possible to suppress reflection at an interface (an interface on the protective layer 55 side) of the common electrode 21 on the light-transmitting substrate 29 side. Therefore, the amount of light which contributes to a display is hardly reduced, and thereby it is possible to display a bright image.

### Modification of Embodiment

In the embodiment described above, a lens surface is configured to have the concave 292, but the invention may be applied to a case where a convex surface-shaped convex (lens surface) is formed in a light-transmitting substrate. Moreover, in the embodiment described above, a lens array of one stage is configured along a propagation direction of light, but the invention may be applied to a case where a lens array of a plurality of stages is configured along a propagation direction of light.

### Example of Mounting to Electronic Apparatus

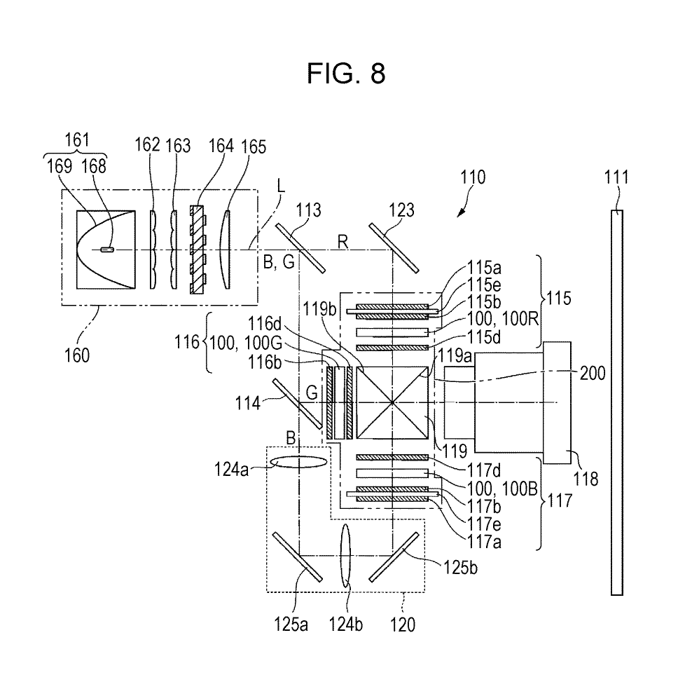

FIG. 8 is a schematic configuration view of a projection-type display device (electronic apparatus) using the electro-optic device 100 to which the invention is applied. In a following description, a plurality of electro-optic devices 100 which are provided with light of different wavelength ranges are used, but the electro-optic device 100 to which the invention is applied is used in any of the electro-optic devices 100.

The projection-type display device 110 shown in FIG. 8 is a liquid crystal projector which uses a transmission-type electro-optic device 100, and display an image by irradiating a projected member 111 made of a screen or the like with light. The projection-type display device 110 includes an illumination device 160, a plurality of electro-optic devices 100 (liquid crystal light valves 115 to 117) which are provided with light emitted from the illumination device 160, a cross dichroic prism 119 (a photosynthesis optical system) which synthesizes and emits light emitted from the plurality of electro-optic devices 100, and a projection optical system 118 which projects light synthesized by the cross dichroic prism 119, along a device optical axis L. In addition, the projection-type display device 110 includes dichroic mirrors 113 and 114, and a relay system 120. In the projection-type display device 110, the electro-optic device 100 and the cross dichroic prism 119 configure an optical unit 200.

In the illumination device 160, a light source unit 161, a first integrator lens 162 made of a lens array of a fly-eye lens and the like, a second integrator lens 163 made of a lens array of a fly-eye lens and the like, a polarization conversion element 164, and a condenser lens 165 are disposed along a device optical axis L in order. The light source unit 161 includes a light source 168 which emits white color light including red color light R, green color light G, and blue color light B, and a reflector 169. The light source 168 is configured by an ultra-high pressure mercury lamp and the like, and the reflector 169 has a parabolic cross-section. The first integrator lens 162 and the second integrator lens 163 uniform illuminance distribution of light emitted from the light source unit 161. The polarization conversion element 164 sets light emitted from the light source unit 161 as polarized light which has a specific vibration direction such as s-polarized light.

A dichroic mirror 113 allows red color light R contained in light emitted from the illumination device 160 to be transmitted and reflects green color light G and blue color light B. The dichroic mirror 114 allows the blue color light B among the green color light G and the blue color light B reflected by the dichroic mirror 113 to be transmitted and reflects the green color G. In this manner, the dichroic mirrors 113 and 114 configure a color separation optical system which separates the light emitted from the illumination device 160 into the red color light R, the green color light G, and the blue color light B.

The liquid crystal light valve 115 is a transmission-type liquid crystal device which modulates the red color light R which is transmitted through the dichroic mirror 113 and reflected by a reflection mirror 123 in response to an image signal. The liquid crystal light valve 115 includes a λ/2 phase difference plate 115a, a first polarized plate 115b, an electro-optic device 100 (an electro-optic device 100R for red color), and a second polarized plate 115d. Here, red color light R incident onto the liquid crystal light valve 115 has unchanged planarization of light even after being transmitted through the dichroic mirror 113, such that s-polarized light remains as it is.

The λ/2 phase difference plate 115a is an optical element which converts s-polarized light incident onto the liquid crystal light valve 115 into p-polarized light. The first polarized plate 115b is a polarized plate which blocks the s-polarized light and allows the p-polarized light to be transmitted. The electro-optic device 100 (the electro-optic device 100R for red color) is configured to convert the p-polarized light into the s-polarized light (if halftone, circularly polarized light or elliptically polarized light) by modulation in response to an image signal. The second polarized plate 115d is a polarized plate which blocks the p-polarized light and allows the s-polarized light to be transmitted. Accordingly, the liquid crystal light valve 115 modulates the red color light R in response to an image signal, and emits modulated red color light R toward the cross dichroic prism 119. The phase difference plate 115a and the first polarized plate 115b are disposed to be in contact with a light-transmitting glass plate 115e whose polarization is not converted, and the λ/2 phase difference plate 115a and the first polarized plate 115b can avoid distortion caused by heat.

A liquid crystal light valve 116 is a transmission-type liquid crystal device which modulates green color light G which is reflected by a dichroic mirror 114 after being reflected by a dichroic mirror 113 in response to an image signal. The liquid crystal light valve 116 includes a first planarized plate 116b, the electro-optic device 100 (electro-optic device 100E for green color), and a second polarized plate 116d in the same manner as the liquid crystal light valve 115. Green color light G incident onto the liquid crystal light valve 116 is s-polarized light reflected by the dichroic mirrors 113 and 114 to be incident. The first polarized plate 116b is a polarized plate which blocks the p-polarized light and allows the s-polarized light to be transmitted. The electro-optic device 100 (electro-optic device 100G for a green color) is configured to convert the s-polarized light into the p-polarized light (if halftone, circularly polarized light or elliptically polarized light) by modulation in response to an image signal. The second polarized plate 116d is a polarized plate which blocks the s-polarized light and allows the p-polarized light to be transmitted. Accordingly, the liquid crystal light valve 116 modulates green color light G in response to an image signal, and emits modulated green color light G towards the cross dichroic prism 119.

The liquid crystal light valve 117 is a transmission-type liquid crystal device which modulates blue color light B that is reflected by the dichroic mirror 113 and passes through a relay system 120 after being transmitted through the dichroic mirror 114 in response to an image signal. The liquid crystal light valve 117 includes a λ/2 phase difference plate 117a, a first polarized plate 117b, an electro-optic device 100 (electro-optic device 100B for blue color), and a second polarized plate 117d in the same manner as the liquid crystal light valves 115 and 116. Blue color light B incident onto the liquid crystal light valve 117 is reflected by two reflection mirrors 125a and 125b of the relay system 120 after being reflected by the dichroic mirror 113 and transmitted through the dichroic mirror 114 to be the s-polarized light.

The λ/2 phase difference plate 117a is an optical element which converts the s-polarized light incident onto the liquid crystal light valve 117 into the p-polarized light. The first polarized plate 117b is a polarized plate which blocks the s-polarized light and allows the p-polarized light to be transmitted. The electro-optic device 100 (electro-optic device 100B for blue color) is configured to convert the p-polarized light into the s-polarized light (if halftone, circularly polarized light or elliptically polarized light) by modulation in response to an image signal. The second polarized plate 117d is a polarized plate which blocks the p-polarized light and allows the s-polarized light to be transmitted. Accordingly, the liquid crystal light valve 117 modulates blue color light B in response to an image signal and emits modulated blue color light B toward the cross dichroic prism 119. The λ/2 phase difference plate 117a and the first polarized plate 117b are disposed to be in contact with the glass plate 117e.

The relay system 120 includes relay lenses 124a and 124b, and reflection mirrors 125a and 125b. The relay lenses 124a and 124b are provided to prevent light loss due to a long optical path of the blue color light B. The relay lens 124a is disposed between the dichroic mirror 114 and the reflection mirror 125a. The relay lens 124b is disposed between the reflection mirrors 125a and 125b. The reflection mirror 125a allows the blue color light B which is transmitted through the dichroic mirror 114 and emitted from the relay lens 124a to be reflected toward the relay lens 124b. The reflection mirror 125b allows the blue color light B emitted from the relay lens 124b to be reflected toward the liquid crystal light valve 117.

The cross dichroic prism 119 is a color combining optical system which orthogonally disposes two dichroic films 119a and 119b in an X shape. The dichroic film 119a is a film which reflects the blue color light B and allows the green color light G to be transmitted, and the dichroic film 119b is a film which reflects the red color light R and allows the green color light G to be transmitted. Accordingly, the cross dichroic prism 119 synthesizes the red color light R, the green color light G, and the blue color light B which are modulated by each of the liquid crystal light valves 115 to 117 to be emitted toward the projection optical system 118.

Light incident onto the cross dichroic prism 119 from the liquid crystal light valves 115 and 117 is the s-polarized light, and light incident onto the cross dichroic prism 119 from the liquid crystal light valve 116 is the p-polarized light. In this manner, it is possible to synthesize light incident from each of the liquid crystal light valves 115 to 117 in the cross dichroic prism 119 by setting light incident onto the crow dichroic prism 119 to be a different type of polarized light. Here, in general, the dichroic films 119a and 119b are excellent in reflection characteristics of the s-polarized light. Thus, the red color light R and the blue color light B which are reflected by the dichroic films 119a and 119b are set to be the s-polarized light, and the green color light G which is transmitted through the dichroic films 119a and 119b is set to be the p-polarized light. The projection optical system 118 has a projection lens (not shown), and projects light synthesized by the cross dichroic prism 119 onto the projection member 111 such as a screen.

### Other Projection-Type Display Device

In the projection-type display device, a transmission-type electro-optic device 100 is used, but a reflective electro-optic device 100 may also be used to configure a projection-type display device. In addition, the projection-type display device may be configured so as to provide each different liquid crystal device with color light emitted from a LED light source using the LED light source and the like which emit light of each color as a light source unit.

### Other Electronic Apparatus

The electro-optic device 100 to which the invention is applied may be used as a direct view type display device in electronic apparatus such as apparatus and the like which include a mobile telephone, personal digital assistants (PDA), a digital camera, a liquid crystal TV, a car navigation device, a TV phone, a POS terminal, and a touch panel in addition to the electronic apparatus.

The entire disclosure of Japanese Patent Application No. 2014-145661, filed Jul. 16, 2014 is expressly incorporated by reference herein.

What is claimed is:

1. A lens array substrate comprising:
a light-transmitting substrate that has a lens surface, the lens surface includes a concave surface or a convex surface is formed on one side surface;
a lens layer which covers one side surface of the substrate, the lens layer is light-transmitting and has a different refractive index from the substrate;
a light-transmitting layer which contains nitrogen and is provided on a side opposite to the substrate with respect to the lens layer;
a protective layer which covers a surface of the light-transmitting layer on a side opposite to the substrate, and is made of a light-transmitting material not containing nitrogen; and
an ITO layer which is formed on a surface of the protective layer on a side opposite to the substrate.

2. The lens array substrate according to claim 1, wherein the protective layer includes any of a silicon oxide film and an aluminum oxide film.

3. The lens array substrate according to claim 1,
wherein the light-transmitting layer includes a silicon oxynitride film.

4. The lens array substrate according to claim 3,
wherein the lens layer includes a silicon oxynitride film, and
the light-transmitting layer covers the lens layer at a surface on a side opposite to the substrate.

5. An electro-optic device which includes the lens array substrate according to claim 1, the electro-optic device comprising:
a device substrate which faces one surface side of the substrate with respect to the lens array substrate; and
a liquid crystal layer which is disposed between the device substrate and the lens array substrate,
wherein the device substrate has an electrode driving a liquid crystal and a first alignment film covering the electrode at the lens array substrate side, formed on a surface of the device substrate facing the lens array substrate, and
the lens array substrate has a second alignment film formed on a surface of the lens array substrate facing the device substrate so as to cover the ITO layer.

6. An electro-optic device which includes the lens array substrate according to claim 2, the electro-optic device comprising:
a device substrate which faces one surface side of the substrate with respect to the lens array substrate; and
a liquid crystal layer which is disposed between the device substrate and the lens array substrate,
wherein the device substrate has an electrode driving a liquid crystal and a first alignment film covering the electrode at the lens array substrate side, formed on a surface of the device substrate facing the lens array substrate, and
the lens array substrate has a second alignment film formed on a surface of the lens array substrate facing the device substrate so as to cover the ITO laver.

7. An electro-optic device which includes the lens array substrate according to claim 3, the electro-optic device comprising:
a device substrate which faces one surface side of the substrate with respect to the lens array substrate; and
a liquid crystal layer which is disposed between the device substrate and the lens array substrate,
wherein the device substrate has an electrode driving a liquid crystal and a first alignment film covering the electrode at the lens array substrate side, formed on a surface of the device substrate facing the lens array substrate, and
the lens array substrate has a second alignment film formed on a surface of the lens array substrate facing the device substrate so as to cover the ITO layer.

8. An electro-optic device which includes the lens array substrate according to claim 4, the electro-optic device comprising:
a device substrate which faces one surface side of the substrate with respect to the lens array substrate; and
a liquid crystal layer which is disposed between the device substrate and the lens array substrate,
wherein the device substrate has an electrode driving a liquid crystal and a first alignment film covering the electrode at the lens array substrate side, formed on a surface of the device substrate facing the lens array substrate, and
the lens array substrate has a second alignment film formed on a surface of the lens array substrate facing the device substrate so as to cover the ITO layer.

9. The electro-optic device according to claim 5,
wherein the liquid crystal layer includes liquid crystal molecules with negative dielectric anisotropy, and
each of the first alignment film and the second alignment film is made of an obliquely deposited film, respectively.

10. An electronic apparatus comprising the electro-optic device according to in claim 5.

11. An electronic apparatus comprising the electro-optic device according to in claim 6.

12. An electronic apparatus comprising the electro-optic device according to in claim 7.

13. An electronic apparatus comprising the electro-optic device according to in claim 8.

14. An electronic apparatus comprising the electro-optic device according to in claim 9.
